(19) United States
(12) Patent Application Publication
(10) Pub. No.: US 2017/0344924 A1
(43) Pub. Date: Nov. 30, 2017

(54) METHOD AND SYSTEM FOR DYNAMICALLY CALCULATING REIMBURSEMENT FOR VEHICLE USAGE

(71) Applicant: Runzheimer International Ltd., Waterford, WI (US)

(72) Inventors: Donna P. Koppensteiner-Reidy, Park Ridge, IL (US); David A. Olson, Delavan, WI (US); Kenneth C. Robinson, Mukwonago, WI (US)

(73) Assignee: Runzheimer International Ltd., Waterford, WI (US)

(21) Appl. No.: 15/602,859

(22) Filed: May 23, 2017

Related U.S. Application Data
(60) Provisional application No. 62/340,881, filed on May 24, 2016.

(51) Int. Cl. G06Q 10/06

(52) U.S. Cl. CPC G06Q 10/06312

(57) ABSTRACT

A method for dynamically calculating a reimbursement rate for vehicle usage including accessing expected cost factors that include a plurality of specific expected costs, deriving a geographically specific regional baseline CPM reimbursement rate that includes the expected cost factors; accessing a geopoint trip record comprised of a sequence of geopoints that include generated cost factors including a plurality of specific generated costs for the driven vehicle, individually comparing generated cost factors with associated expected cost factors to determine if the generated cost factors are greater than, less than, or equal to the expected cost factors, generating a positive cost allotment for each generated cost factor that is greater than the associated expected cost factor, generating a negative cost allotment for each generated cost factor that is less than the associated expected cost factor, and deriving a dynamic CPM reimbursement rate by adjusting the geographically specific regional baseline CPM reimbursement rate.

### CROSS-REFERENCE TO RELATED APPLICATION

This application claims priority to U.S. Provisional Patent Appl. No. 62/340,881 filed on May 24, 2016, the disclosure of which is incorporated herein by reference in its entirety for all purposes.

### RELATED FIELD

The method and system for dynamically calculating reimbursement for vehicle usage relates generally to calculating reimbursement costs for vehicle usage.

### BACKGROUND

It is common for an employee to use their personal vehicle to perform business-related travel. When this occurs, the employee generally seeks reimbursement for the costs associated with the use of their vehicle, such as fuel, depreciation, maintenance, etc. This type of reimbursement is generally calculated using a fixed cents-per-mile value that is multiplied by the number of miles driven on the vehicle to provide the monetary reimbursement. As numerous variables exist with regard to the actual cost of operating the employee's vehicle, the cents-per-mile value is generally derived from an average value for travel cost, provided by a third party, such as the Internal Revenue Service's standard mileage rate. Although this value can provide an employee with a general level of reimbursement, it does not take into account numerous cost variables such as the type of vehicle, geographic region it is operated in, and actual driving conditions. These cost variables, among many others, can significantly affect the “actual” cost of operating the vehicle, and therefore when not specifically analyzed, may result in either the employee being under compensated for the use of the employee's vehicle, or the employer overpaying the employee for the use of the vehicle.

### BRIEF SUMMARY

In at least some embodiments, a method and system for dynamically calculating reimbursement for vehicle usage is disclosed that includes: deriving expected cost factors related to the operation of a vehicle; deriving a geographically specific regional baseline cents-per-mile reimbursement rate based on the expected cost factors; forming a geopoint trip record using vehicle input data received from a driven vehicle and a sequence of geopoints obtained from a plurality of sensory input devices, wherein the sensory input devices are associated and in communication with the driven vehicle, and the geopoints include generated cost factors associated with the driven vehicle; comparing the generated cost factors with expected cost factors to determine if the generated cost factors are greater than, less than, or equal to the expected cost factors; generating positive cost allotments for the generated cost factors that are greater than the expected cost factors; generating negative cost allotments for the generated cost factors that are less than the expected cost factors; and deriving a dynamic cents-per-mile reimbursement rate by adjusting the geographically specific regional baseline cents-per-mile reimbursement rate; wherein the adjustment includes adding the positive cost allotments to the geographically specific regional baseline cents-per-mile reimbursement rate and subtracting the negative cost allotments. Other embodiments, aspects, and features will be understood and appreciated upon a full reading of the detailed description and the claims that follow.

In at least some other embodiments, a method and system for dynamically calculating reimbursement for vehicle usage is disclosed that includes: deriving expected cost factors related to operation of a sample vehicle; deriving a geographically specific regional baseline cents-per-mile reimbursement rate based on the expected cost factors; forming a geopoint trip record using a sequence of geopoints obtained from at least one of a plurality of sensory input devices, wherein the plurality of sensory input devices are associated and in communication with a driven vehicle, and the geopoints include generated cost factors associated with the driven vehicle; comparing the generated cost factors with expected cost factors to determine if the generated cost factors are greater than, less than, or equal to the expected cost factors; generating positive cost allotments for the generated cost factors that are greater than the expected cost factors; generating negative cost allotments for the generated cost factors that are less than the expected cost factors; and deriving a dynamic cents-per-mile reimbursement rate by adjusting the geographically specific regional baseline cents-per-mile reimbursement rate; wherein the adjusting includes adding the positive cost allotments to the geographically specific regional baseline cents-per-mile reimbursement rate and subtracting the negative cost allotments.

In at least some yet other embodiments, a method and system for dynamically calculating reimbursement for vehicle usage is disclosed that includes: accessing from a data store, expected cost factors that include a plurality of specific expected costs for a sample vehicle; deriving a geographically specific regional baseline cents-per-mile reimbursement rate that includes the expected cost factors; accessing a geopoint trip record comprised of vehicle input data received from a driven vehicle and a sequence of geopoints obtained from at least one of a plurality of sensory input devices, wherein the sensory input devices are associated with the operation of the driven vehicle, and the geopoints include generated cost factors that include a plurality of specific generated costs for the driven vehicle, individually comparing generated cost factors with associated expected cost factors to determine if the generated cost factors are greater than, less than, or equal to the expected cost factors; generating a positive cost allotment for each generated cost factor that is greater than the associated expected cost factor; generating a negative cost allotment for each generated cost factor that is less than the associated expected cost factor; and deriving a dynamic cents-per-mile reimbursement rate by adjusting the geographically specific regional baseline cents-per-mile reimbursement rate; wherein the adjusting includes adding the positive cost allotments to the geographically specific regional baseline cents-per-mile reimbursement rate and subtracting the negative cost allotments.

### BRIEF DESCRIPTION OF THE DRAWINGS

Embodiments of the method and system for dynamically calculating reimbursement for vehicle usage are disclosed with reference to the accompanying drawings and are for illustrative purposes only. The method and system for dynamically calculating reimbursement for vehicle usage is not limited in its application to the details of construction or the arrangement of the components illustrated in the drawings. The method and system for dynamically calculating reimbursement for vehicle usage is capable of other embodiments or of being practiced or carried out in other various ways. In the drawings:

FIG. 1 is an exemplary schematic diagram of a system for calculating a dynamic cents-per-mile (CPM) reimbursement rate for vehicle travel;

FIG. 2 is an enhanced view of portions of the exemplary system for calculating a dynamic CPM reimbursement rate for vehicle travel;

FIG. 3 is an exemplary flowchart 300 for calculating and disbursing a dynamic CPM reimbursement rate;

FIG. 4 is an exemplary map showing a plurality of geopoints;

FIG. 5 is a table that includes exemplary data for a geopoint trip record; and

FIG. 6 is another table that includes exemplary data for a geopoint trip record.

### DETAILED DESCRIPTION

The method and system for dynamically calculating reimbursement for vehicles generates a dynamic CPM reimbursement rate for individuals who use their personal vehicle for business driving. This solution incorporates sensing technology to adjust a geographically specific regional baseline CPM reimbursement rate to better align the reimbursement with the true costs experienced by an individual. This end-to-end reimbursement solution provides the policy, process and controls necessary to deliver a complete solution. This solution provides, among other things, the ability to leverage technology inputs to determine a CPM reimbursement rate for a geographically specific region (e.g., metro area, county, state, country, etc.) that accounts for both ownership and driving costs in the exact location where business miles are driven.

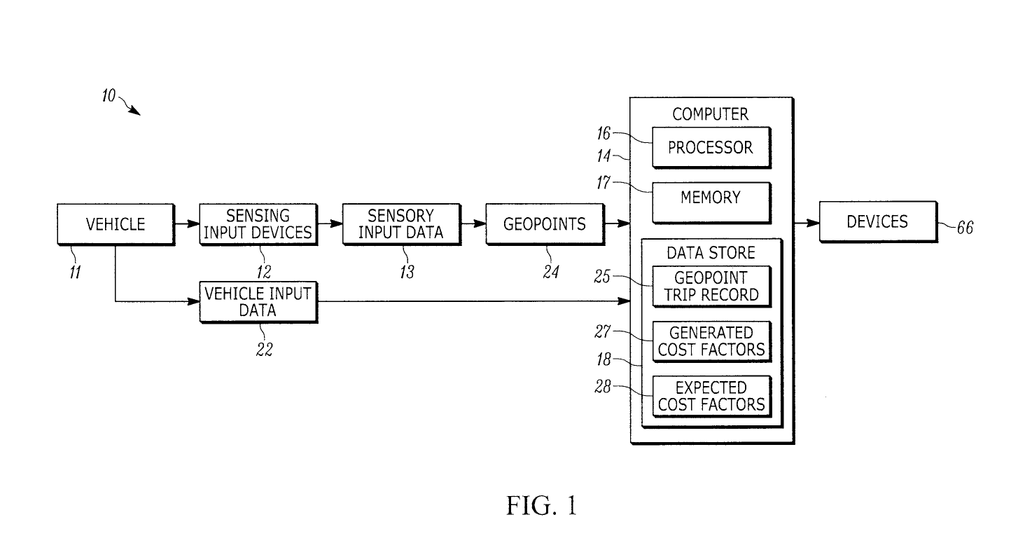

Referring to FIG. 1, an exemplary schematic diagram of a system 10 for calculating a dynamic CPM reimbursement rate for vehicle travel, noting that a driven vehicle 11 can be excluded as part of the system 10. To calculate the dynamic CPM reimbursement rate, the system 10 utilizes numerous cost factors, including expected cost factors and dynamically generated cost factors. Some of the cost factors are static, based on the type of vehicle for example, while others are dynamic based on the geography of the terrain the vehicle is traveling on and the manner in which the vehicle is being driven. The expected cost factors can include expected values for various vehicle-related costs, such as fuel, maintenance, depreciation, and tires, which are then combined to provide a geographically specific regional baseline CPM for a sample vehicle. It is to be understood that fuel can include any one of or a combination of fuel types, such as gasoline, electric, hydrogen, hybrid, etc. It is to be further understood that a “sample vehicle” can be comprised of an exemplary vehicle having, in at least some embodiments, a specific make, model, and/or year, while in other embodiments, other identifying criteria may be used, such as primary use (passenger vehicle for sales activities, pick-up truck for service, Van for deliveries, semi-tractor for hauling materials, etc.). By adjusting, as needed, the geographically specific regional baseline CPM based on a comparison of the static expected cost factors and the dynamically generated cost factors, a dynamic CPM reimbursement rate that provides a substantially accurate cost for the operation of the vehicle driven during a specific trip can be provided.

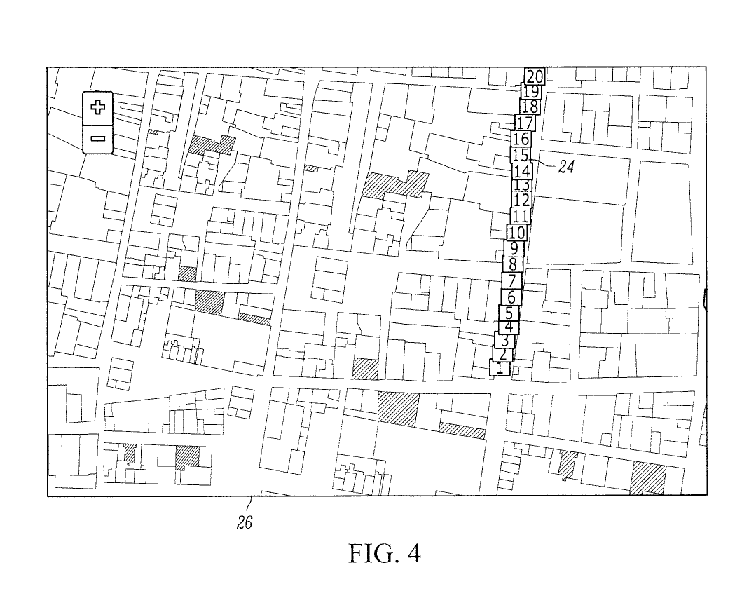

In at least some embodiments, the system 10 includes a plurality of sensory input devices 12, a computer 14 having a processor 16, a memory 17, and a data store 18, wherein the data store 18 can include any of various data storage mediums, such as digital hard drives, ROM, REM, solid state recorders, cloud-based storage, etc., and wherein the data store 18 includes the software instructions that interface with the processor 16 to perform the method as discussed herein. The sensory input devices 12 generate sensory input data 13 related to the status and operation of the driven vehicle 11, wherein the driven vehicle 11 is understood to include for example, a vehicle driven a distance by an operator seeking reimbursement for the distance (miles) driven in the driven vehicle 11. The sensory input data 13 is aggregated at a periodic sampling rate (e.g., every 3 seconds) to form geopoints 24, wherein a string of geopoints 24 form a geopoint trip record 25 that is communicated to the computer 14. In at least some embodiments, the geopoints 24 can be communicated to the computer 14 individually or as a partial or complete geopoint trip record 25. In at least some embodiments, the geopoint trip record 25 is a string of geopoints 24 that can be formed by capturing sensory input data 13 (see FIG. 4). Further, in at least some embodiments, a single geopoint 24 can include one or more of the following fields:
i) a geopoint type that is used to identify the start, middle and end of a trip record;
ii) latitude coordinates;
iii) longitude coordinates;
iv) an accuracy value (horizontal accuracy) that measures the accuracy of the recorded geopoint in meters;
v) date/time/time zone adjustment that the vehicle began to travel;
vi) date/time/time zone adjustment that the geopoint was captured;
vii) the direction of travel, calculated by deciphering the direction of travel using the previous and current GPS coordinates;
viii) speed of travel;
ix) altitude (in meters) of the geopoint; and
x) a geopoint identifier.

The system 10 records geopoints 24 and organizes strings of geopoints 24 into one or more geopoint trip records 25. Vehicle input data 22 related to the operation and condition of the driven vehicle 11 as well as other data such as various conditions the driven vehicle 11 is operated under, can also be provided to the computer and aggregated with the geopoints 24 to form the geopoint trip record 25. Communication of any data to the computer 14 can occur in real time using one or of various wireless communication methods (e.g. asynchronous, cellular, Bluetooth, Wi-Fi, mesh network, other data transfer technology fourth and fifth generation wireless, 4G/5G networks, etc.). Communication to the computer can also occur at regular or/and irregular intervals, when a wireless communication is available if one is not always present. Once the geopoints 24 and/or the vehicle input data 22 have been communicated to the computer 14 and aggregated to form the geopoint trip record 25, the computer 14 extracts generated cost factors 27 from the geopoint trip record 25 for comparison with expected cost factors 28, as discussed in detail below.

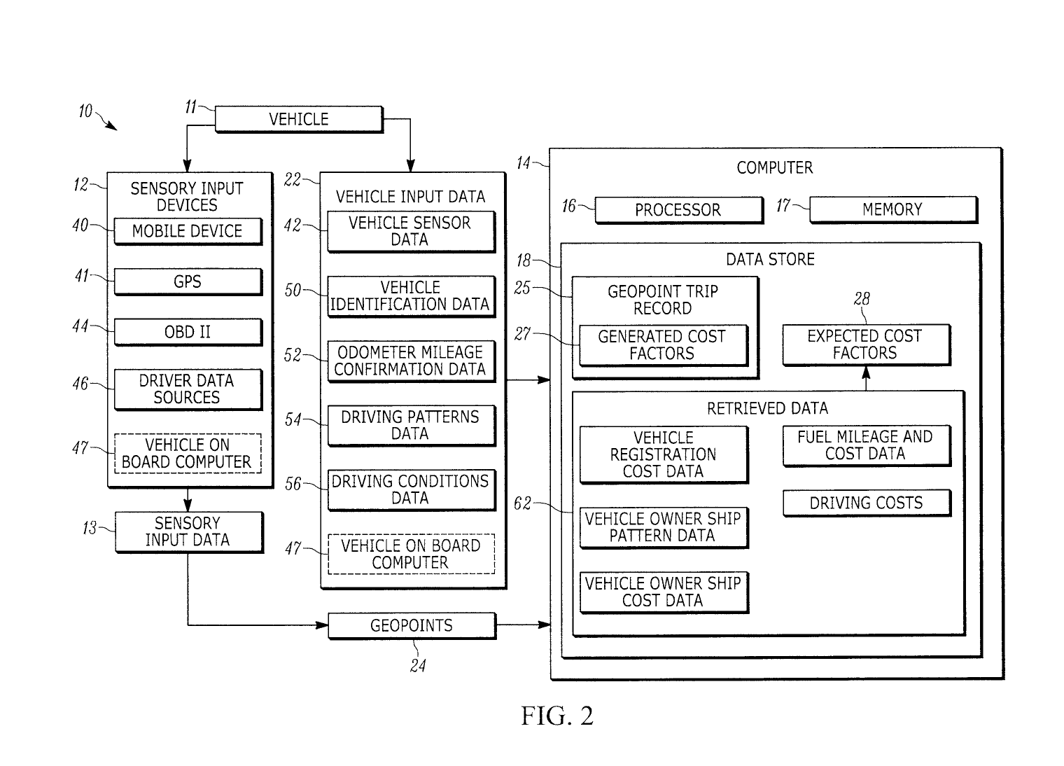

Referring to FIG. 2, an enhanced view of portions of the exemplary system 10 is provided. As discussed above, the sensory input devices 12 obtain sensory input data 13 at least indirectly from the driven vehicle 11. Sensory input devices 12 can include one or more of various devices, such as a mobile device 40 (e.g., cellular phone, tablet, laptop computer, etc.), a GPS device 41, an OBD II module 44, driver data sources 46, vehicle onboard computers 47, etc., which are capable of monitoring one or more dynamic data points related to the vehicle 11 and its operational characteristics. The sensory input devices 12 can be utilized singularly or in combination to obtain the sensory input data 13 from the vehicle 11 and its operation. In addition, the vehicle input data 22 can include one or more categories of data, such as, vehicle sensor data 42, data from a vehicle onboard computer 47, vehicle identification data 50, odometer mileage confirmation data 52, driving pattern data 54, and driving conditions data 56. Some of this data can be static and is used to confirm initial registration data or other assumed details of the vehicle 11, while other data is dynamically provided during operation of the vehicle 11 by an operator of the vehicle (i.e., the driver). Initial registration data can be provided by the operator and communicated to the computer 14 as vehicle input data 22 or as sensory input data 13 at the start of a trip. Such data can include the make, model, and year of the vehicle 11, as well as the current mileage, and other vehicle details. It is to be understood that the vehicle input data 22 can be generated and communicated by the sensory input devices 12 or provided to the computer 14 in other manners. It is to be further understood that data that is one or more of received, generated, and communicated to the computer can be identified in at least some embodiments as sensory input data 13 or vehicle input data 22, regardless of the exemplary grouping shown in FIGS. 1 and 2.

As noted above, vehicle input data 22 can be comprised of various types of data, for example, vehicle identification data 50, which can include various elements related to the vehicle 11, such as: Vehicle Identification Number (VIN), engine type, vehicle type, make, model, model year, series, sub-series, body style, drive type (e.g. 2-wheel, 4-wheel, AWD, etc.). Odometer mileage confirmation data 52 can include the odometer values at the start and end of a trip as provided by the vehicle itself or the miles driven as provided by an associated sensory input device 12 (e.g., a mobile phone). Driving pattern data 54 is collected and analyzed for each specific driver based on the geographic area they are driving to determine the road type for accurate fuel consumption cost allocation and to identify inefficient and dangerous driving behaviors. Driving pattern data 54 can include route characteristics, driver behavior data, tire data, etc. Route characteristics can include, for example, geolocation identifiers that capture the vehicles exact coordinates for each geopoint 24, and fuel mileage rate for each geopoint 24, or the average fuel cost for the trip. The route characteristics can also include the road type by looking up geopoint coordinates (exact location) and cross-referencing with Department of Transportation data and other cartographic data sources like BING MAPS or GOOGLE MAPS. Driver behavior data can include, for example, occurrences of rapid acceleration and deceleration, as well as the consistency of the vehicle speed. Tire data can be obtained from tire pressure sensors installed in the vehicle 11. These sensors can in some iterations, provide data indicating friction level, pressure, traction level, tread quality, etc.

Driving conditions data 56 can be collected for each geopoint 24 when available. Driving conditions data 56 can include specific conditions experienced by drivers in a dynamic manner, for example, road conditions signified by excessive vibration sensed by one or more sensory input devices 12, the current weather conditions, and if a toll payment was due. Driving conditions data 56 can also include the date and time of travel, as well as vehicle-sensed data, such as the duration of vehicle idling when in drive and park modes, blind spot detection sensor data, traction control engagement, antilock brake engagement, assisted brake engagement, etc.

The sensory input data 13 that is obtained periodically from the sensory input devices 12 as geopoints 24, is communicated to the computer for storage in the data store 18. This communication can occur when one or more of the sensory input devices 12 or the vehicle 11 has data connectivity (asynchronous, Wi-Fi, mesh network, cellular connection, etc.) to the computer 14, or an associated device that in turn, can communicate with the computer 14. Such communication can take place during a trip while a connection is available, or post trip if necessary. For example, the geopoints 24 can be downloaded locally from one or more of the sensory input devices 12 to a portable media device after a trip, and then uploaded to the computer 14 to perform the dynamic CPM calculation. Likewise, the vehicle input data 22 can be communicated to the computer 14 and data store 18.

As noted above, when combined, the geopoints 24 form the geopoint trip record 25 that includes the desired generated cost factors 27 that will be compared with the expected cost factors 28. In calculating the dynamic CPM reimbursement rate, a geographically specific regional baseline CPM for a specific type or category of vehicle is calculated for comparison purposes. The geographically specific regional baseline CPM for a specific type of vehicle is derived by calculating the expected cost factors 28 using retrieved data 62 obtained from sources external to the vehicle 11. The retrieved data 62 can include data from numerous publicly available sources, such as websites and databases, and if available, can include private databases. In at least some embodiments, the retrieved data 62 can be supplemented by prior generated cost factor data stored from previous geopoint trip records. The retrieved data 62 is intended to cover the use costs for a geographically specific regional baseline vehicle that would be similar to the vehicle 11. The use costs consist of the expected costs that typical vehicle owners experience to drive/operate a specific type of vehicle within a specific region. Various methods can be used to determine the expected cost factors 28 for the geographically specific regional baseline CPM, although in at least some embodiments, expected cost factors 28 are derived using retrieved data 62 that includes one or more of: vehicle registration data, vehicle ownership pattern data, vehicle ownership cost data, fuel mileage and cost data or electric mileage and cost data, and driving costs.

Vehicle registration data can be used to determine the types of vehicles typically registered in a given geographically specific region and the purchase price. Use of the vehicle registration information narrows the focus of costs to vehicles that are typically purchased and driven within a geographically specific region in order to provide a suitable geographically specific regional baseline cost. In at least some embodiments, the vehicle registration data is collected and analyzed from various sources to identify the appropriate set of vehicles for a region. Appropriate vehicles can be defined in one or more of various ways, for example: (i) the most commonly registered vehicles; (ii) vehicles comprising a specified percentage of registrations; (iii) vehicles of a particular class or grouping (e.g., midsize, full-size, trucks, etc.). In addition to identifying an appropriate set of vehicles for a region, vehicle registration data can be obtained based on a specific vehicle in some applications or alternatively can be data segmented, for example, by Luxury/Non-Luxury in the following exemplary vehicle categories: Sport, Sub-compact, Compact, Mid-Size, Full-Size, Compact CUV/SUV/Van, Mid-Size CUV/SUV/Van, Full Size SUV, Full Size Van, Mid-Size Pick-Up, Full-Size Pick-Up. The vehicle registration data can include various attributes for each of the vehicle categories, for example: make, model, model year, series, sub-series, body style, drive type (e.g. 2-wheel, 4-wheel, AWD, etc.), fuel type, vehicle type, Manufacturer Suggested Retail Price (MSRP), transaction price, selling dealer info, etc.

In at least some embodiments, vehicles are weighted equally within the vehicle categories based on most commonly registered vehicles in a geographically specific region. The top tier (most commonly registered) vehicles can be defined as those that comprise 75% (or a heavily weighted percentage greater than 50%) of vehicles driven in a geographically specific region segment. Vehicle identification data derived from these sources may be aggregated and weighted by vehicle class (e.g., Economy, Full-Size, Truck/SUV, etc.). Additionally, vehicles within a class may be weighted based on common use in a particular geographically specific region.

Sources for the vehicle registration data can include for example, the Department of Transportation, individual state Department of Motor Vehicle databases, private companies (e.g., Information Handling Services, Inc.), and other public or private databases. Using one or more of the various sources, the vehicle registration data can be obtained or updated periodically, such as monthly, quarterly, semi-annually or annually.

Ownership patterns determine the typical number of years vehicles are retained and the number of miles driven per year. The ownership information provides a basis for understanding how vehicles depreciate over time and affects overall resale values. Data can be obtained from various sources, such as U.S. State Departments of Transportation, Information Handling Services Inc., and the National Automobile Dealers Association (NADA). Retention cycles are determined by analyzing used vehicle registration data using regression analysis and calculating an average number of years that drivers typically retain their vehicle. This retention cycle can vary by geographically specific region and/or vehicle class. Once the retention cycle and average annual miles driven are calculated, these components can be used to calculate depreciation costs.

Ownership cost data consist of the associated costs that a vehicle owner (i.e. person or entity that maintains ownership rights for a vehicle, such as a corporation that provides vehicles for use by its employees) realizes based on ownership within a specific region, such as, vehicle purchase price, depreciation, sales tax, licensing, registration, insurance, and other related fees. Ownership cost data can be collected and analyzed from various sources based upon vehicle registration patterns and ownership patterns for a given region. Sales tax data can be obtained from U.S. State Departments of Transportation and other geographically specific region government websites to determine the cost in a specific region. Vehicle purchase price and depreciation can be obtained from resources such as, Black Book, Blue Book, NADA, etc. These costs can be broken down by make, model, etc. Depreciation is calculated using a straight-line depreciation method: Vehicle purchase price (including taxes, licensing, and fees) less the value of the vehicle at the end of the retention cycle, divided by the number of years in the retention cycle, equals the annual depreciation cost. The cost to annually insure a vehicle is based on: make, model, year, trim, coverage levels, and driver-type, are based on the geographically specific region a driver lives in. This information can be obtained from various sources, such as Quadrant, Inc. and Applied Systems, Inc.

Utilizing ownership cost data can provide a geographically specific regional baseline CPM rate that aligns closely with true regional specific costs. In at least some embodiments, ownership costs can be calculated as follows:

annual depreciation+annual taxes+annual license+annual registration+insurance costs=annual ownership costs

This annual ownership cost is divided by the average annual miles to provide an expected ownership cost factor in terms of CPM for a specific vehicle (or vehicle class).

Driving costs consist of the elements that vehicle owners realize to drive/operate a vehicle within a specific region. These include, but are not limited to, fuel cost, routine maintenance, and tires. Driving cost data is collected and analyzed from various sources, such as NAVIGANT, REPAIRPAL, TIRERACK, etc. Each cost component is appropriately determined by understanding the geographically specific regional costs for each component. For example, routine maintenance costs take into consideration the length of time a vehicle is retained, the type of driving performed, and the driving conditions. For example, a geographically specific region where there is heavy traffic may require more frequent routine maintenance, increasing the expected maintenance cost factor. Calculating geographically specific regional driving costs ensures the CPM rate aligns closely with true regional costs. Updates can occur dynamically or otherwise as desired.

Routine maintenance costs can be estimated using the suggested manufacturer schedule of routine maintenance (e.g., brake replacement, oil changes, etc.) for a specific vehicle, in combination with the estimated cost of labor and parts in a specific region. Geographically specific region sensitive labor and parts costs are added together for each unique maintenance element needed to be performed on the vehicle multiplied by the number of times that element will be performed in the course of one year based on the retention cycle divided by the average annual miles equals the estimated maintenance cost factor in terms of CPM. When available, data from a specific driver can be analyzed using regression analysis to calculate the frequency of needed maintenance. Frequency can be determined by using a minimum baseline of a vehicle manufacture's recommended service schedule and analyzing dynamic driving pattern data to determine whether the maintenance schedule must be accelerated. The resulting maintenance schedule, along with the geographically specific regional sensitive cost of labor and parts for each maintenance element performed, comprise the elements needed to calculate the cost of maintenance per mile/trip based on using all of the aforementioned variables in the driver's specific region.

Fuel mileage and fuel or electricity cost data can be obtained by any of numerous publically available resources. The expected fuel mileage for any vehicle is provided by its manufacturer as well as other consumer sources. The regional cost for fuel and electricity is also available through numerous resources. In at least some embodiments, calculating the expected fuel cost factor in terms of CPM is accomplished using one of the following methods: calculating the expected gasoline fuel cost factor would require dividing the number of cents-per-gallon cost by the number of miles-per-gallon; calculating the expected electric fuel cost factor would require dividing the number of cents-per-electric kilowatt hour fuel cost by the number of miles-per-kilowatt hour; calculating the expected hydrogen fuel cost factor would require dividing the number of cents-per-kilogram fuel cost by the number of miles-per-kilogram; and calculating the expected hybrid fuel cost factor would require multiplying the percent of electricity used per mile by the expected electric fuel cost factor, also multiplying the percent of gasoline used per mile by the expected gasoline fuel cost factor, and adding the two results together. In other embodiments, the fuel cost factor can be determined using other methods.

Tire cost can include many elements, such as the geographically specific regional need for snow tires, which would require a pro-rated cost adjustment. In general, the manufacturer's suggested tires for a vehicle in a geographically specific region can be identified for a specific vehicle along with the estimated tread-life in miles. The cost to purchase the tires, mount the tires, and balance the tires can be obtained for the geographically specific region sought. The total cost for replacement of the recommended tires can be divided by the estimated tread-life to obtain an estimated tire cost factor in terms of CPM.

When available, previously obtained data for a particular driver can be analyzed using regression analysis to calculate the frequency of needed tire replacement for a specific vehicle. This would provide an expected tire cost factor that is more accurate than non-driver specific data. Frequency of replacement is determined by using a minimum baseline of a manufacture's recommended service schedule and analyzing the dynamic driving pattern data to determine whether the tire replacement schedule should be accelerated. The resulting tire replacement schedule, along with the geographically specific regional sensitive cost of labor and parts, comprise the elements needed to calculate the cost of tires per mile/trip based on use of the aforementioned variables in the driver's geographically specific region. Geographically specific regional sensitive labor and parts costs are added together for each tire replacement to be performed on the vehicle, multiplied by the number of times that tires will be replaced over the course of the retention cycle, divided by the number of years in the retention cycle, which then equals the annual expected cost of tires.

Combining the expected cost factors 28 provides a geographically specific regional baseline CPM rate from which further modifications can be made to generate the dynamic CPM reimbursement rate. Several of the expected cost factors 28 are not expected to conflict with the generated cost factors 27, for example, the make and model of the vehicle 11 can be entered as an expected cost factor 28, such as during registration, and the make and model information can also be sensed by one of the sensory input devices 12 or provided as vehicle input data 22, which would typically confirm that they are the same. This can hold true for various expected cost factors 28. In contrast, many expected cost factors 28 can vary notably from the generated cost factors 27, particularly with regard to the actual operation of the vehicle 11 by a particular driver. For example, expected cost factors related to tires, maintenance, and fuel cost can vary based on how a vehicle is driven (gently versus rough), and therefore would require adjustments to reflect the actual cost of operating the vehicle during a specific trip. To determine the actual cost, namely the dynamic CPM reimbursement rate, the geographically specific regional baseline CPM rate derived from the expected cost factors 28 is modified based on a comparison of numerous expected cost factors 28 with the generated cost factors 27, as discussed with regard to flowchart 300 below.

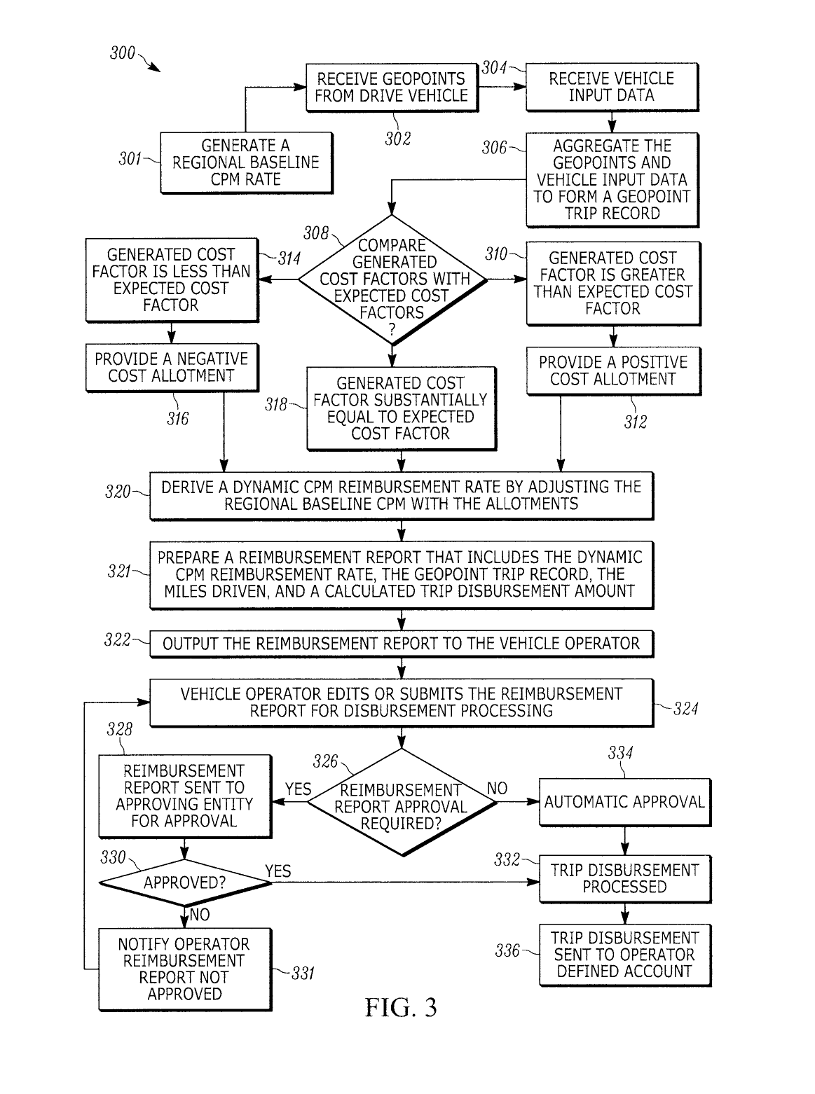

Referring to FIG. 3 an exemplary flowchart 300 for calculating the dynamic CPM rate is provided. It is to be understood that a “driven vehicle” is representative of a specific vehicle that a driver has accrued actual miles on, and to which reimbursement of the associated costs of the driven miles is sought by the driver.

The calculation begins at step 301 by calculating the geographically specific regional baseline CPM rate based on the expected cost factors 28 that have been stored in the data store 18. Next, at step 302 geopoints that include sensory input data 13 from the sensory input devices 12 are received by the computer 14 and stored in the data store 18, wherein the sensory input data 13 can be sampled at periodic intervals (e.g., every 3 seconds) to generate the plurality of geopoints 24 that represent the states of the vehicle 11 over a time period (i.e., a trip). Each geopoint 24 includes a plurality of generated cost factors 27. At step 304, vehicle input data 22 is received by the computer 14 and stored in the data store 18. At step 306, the processor 16 aggregates the geopoints 24 and vehicle input data 22 to generate the geopoint trip record 25 that includes all of the generated cost factors 27. At step 308, the computer 14 compares the generated cost factors with expected cost factors 28 stored in the data store 18.

A comparison of the generated cost factors 27 with the expected cost factors 28 (e.g., the sensed duration of rapid deceleration is compared to the expected duration of rapid deceleration) can identify a necessary adjustment to the geographically specific regional baseline CPM rate. For example, as noted in step 310, if one of the generated cost factors 27 (e.g., actual sensed duration of rapid deceleration) exceeds the associated expected cost factor 28 (e.g., expected duration of rapid deceleration), this would indicate increased wear on the vehicle tires and brakes, therefore in step 312 a positive cost allotment for the geographically specific regional baseline CPM rate would be provided to reflect the increased cost associated with the tires and brakes. In contrast, in step 314, if one of the generated cost factors 27 (e.g., actual duration of rapid deceleration) is less than the expected cost factor (e.g., expected duration of rapid deceleration), this would indicate decreased wear on the vehicle tires and brakes, so in step 316, a negative cost allotment for the geographically specific regional baseline CPM rate would be provided to reflect the reduced wear and its resultant cost. If one of the generated cost factors 27 is equal to the expected cost factor (e.g., actual duration of rapid deceleration substantially equals the expected duration of rapid deceleration), as noted in step 318, then no cost allotment is provided based on that specific generated cost factor.

Continuing to step 320, the dynamic CPM reimbursement rate is calculated by adding positive cost allotments to the geographically specific regional baseline CPM rate and subtracting negative cost allotments. In step 321, a reimbursement report is prepared that can include one or more of: the dynamic CPM reimbursement rate, any generated and/or expected cost factors associated with a trip, cost allotments, the geopoint trip record 25, the number of miles driven, and a calculated trip disbursement amount (the dynamic CPM reimbursement rate multiplied by the miles driven).

In step 322, the reimbursement report is outputted to a device 66 for the vehicle driver to review, such as the driver's mobile device 40 or a vehicle-based application. After review, as noted in step 324, the driver can either request corrections, or if accurate, submit the reimbursement report for trip disbursement processing, which can include required approval (e.g., by an employer) or no approval requirements. The submission process can invoke optional approval steps defined by an employer of the driver, as noted in step 326, allowing an approving entity, such as a driver's manager to review/approve the reimbursement report. In at least some embodiments, the approving entity can include a supervisor or other designated company employee, such as an accountant, and can further include an individual from an outside firm hired by the driver's employer to review the reimbursement reports. In addition, the computer 14 or another processing device described herein or otherwise in communication with the system can also be configured to provide approval based on the data provided in the reimbursement report falling within set guidelines. If approval is required, as noted in step 328, then approval of the reimbursement report in step 330 will move the process to step 332, where the trip disbursement amount is processed for payment to the driver. If not approved in step 328, then the process can move to step 331 to notify the driver of the non-approval and then return to step 324 to allow the driver to further edit the reimbursement report and resubmit the reimbursement report for approval, or otherwise take action to seek approval by other means. If no manager approval is required, as in step 334, the approval process can then be automatic, moving directly to step 332.

In step 336, once approval steps are completed, such as in accordance with the employer's policy, including the ability to reject or edit a submitted reimbursement report, the trip disbursement amount payment can be directly provided to the driver using any one of various payment methods supported by the employer (e.g., check, direct deposit, PayPal, etc.). Using the aforementioned process allows payments to be made on a per-trip basis, at any time interval defined by the employer instead of being limited to periodic batch transactions. In at least some embodiments, instead of moving from step 324 to step 326, submitted reimbursement reports from step 324 can be communicated via an application programming interface (API) connection into an employer's travel and expense system to be reviewed, accepted or approved, and then paid using an internal travel and expense mechanism.

Upon completion of the process or any time prior, the various portions of the data can be saved to the data store 18 for later use. Generating a library of dynamic CPM rates and generated cost factors 27 for specific vehicles, drivers, and/or regions can assist with modifying or updating the expected cost factors 28. In addition, the retrieved data 62 can be obtained and updated at a high frequency to further enhance the accuracy of the expected cost factors 28 derived thereform.

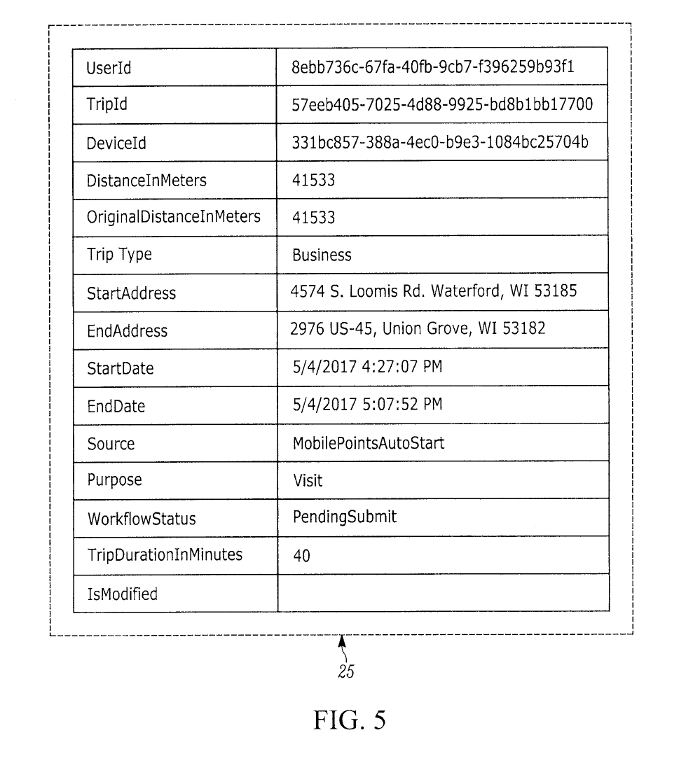

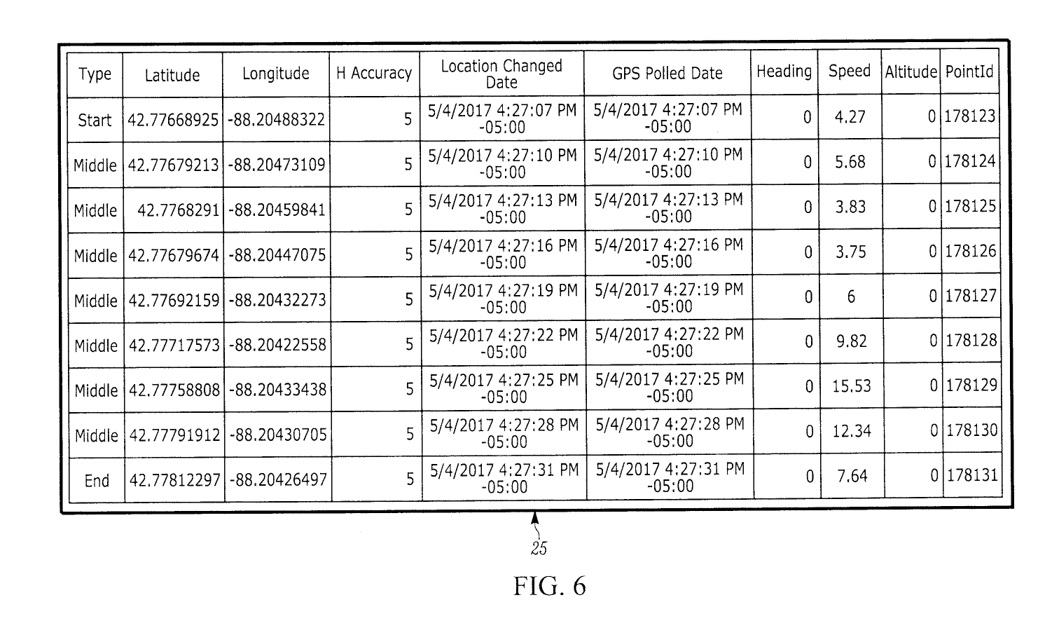

FIG. 4 illustrates an exemplary map 26 showing a plurality of geopoints 24 generated by a driven vehicle 11 along a route. As noted above, a geopoint trip record can include a plurality of data. In at least some embodiments, a geopoint trip record 25 can include data such as shown in FIG. 5 which includes a table of exemplary data for a geopoint trip record, while in other embodiments, a geopoint trip record 25 can include data such as found in FIG. 6 illustrating a table of exemplary data for a geopoint trip record. Further, a geopoint trip record 25 can include more or less than the data shown in either tables or both tables, along with additional related data.

It is specifically intended that the aforementioned method and system for dynamically calculating reimbursement for vehicle usage not be limited to the embodiments and illustrations contained herein, but include modified forms of those embodiments including portions of the embodiments and combinations of elements of different embodiments as come within the scope of the following claims. In addition, the various methods described herein can include additional steps not described herein or can omit steps described herein. Further, the various steps can be performed in a different order than described herein. The use of the term “plurality” shall be understood to include one or more of a specified element. Communication between the components described herein can occur via numerous known wired and wireless electronic communication methods, for example, cellular, Bluetooth, Wi-Fi, NFC, etc.

What is claimed is:

1. A method for dynamically calculating reimbursement for vehicle usage comprising:
deriving expected cost factors related to operation of a sample vehicle;
deriving a geographically specific regional baseline cents-per-mile reimbursement rate based on the expected cost factors;
forming a geopoint trip record using vehicle input data received from a driven vehicle and a sequence of geopoints obtained from at least one of a plurality of sensory input devices, wherein the plurality of sensory input devices are associated and in communication with the driven vehicle, and the geopoints include generated cost factors associated with the driven vehicle;
comparing the generated cost factors with expected cost factors to determine if the generated cost factors are greater than, less than, or equal to the expected cost factors;
generating positive cost allotments for the generated cost factors that are greater than the expected cost factors;
generating negative cost allotments for the generated cost factors that are less than the expected cost factors; and
deriving a dynamic cents-per-mile reimbursement rate by adjusting the geographically specific regional baseline cents-per-mile reimbursement rate; wherein the adjusting includes adding the positive cost allotments to the geographically specific regional baseline cents-per-mile reimbursement rate and subtracting the negative cost allotments.

2. The method of claim 1, further comprising calculating a trip disbursement amount that includes the dynamic cents-per-mile reimbursement rate multiplied by miles accrued on the driven vehicle during a trip.

3. The method of claim 2, further comprising generating a reimbursement report that includes at least one of the trip disbursement amount, the dynamic cents-per-mile reimbursement rate, the geopoint trip record, and the miles accrued.

4. The method of claim 3, further comprising communicating the reimbursement report to at least one of an owner and an operator of the driven vehicle.

5. The method of claim 4, further comprising submitting via at least one of the owner and the operator of the driven vehicle, the reimbursement report for disbursement processing.

6. The method of claim 5, wherein disbursement processing includes providing the trip disbursement amount to at least one of the owner and the operator of the driven vehicle.

7. The method of claim 6, wherein the trip disbursement amount is provided via electronic transfer.

8. The method of claim 5, wherein disbursement processing includes requesting approval from an approving entity.

9. The method of claim 8, wherein upon receiving approval the trip disbursement amount, the trip disbursement amount is provided via electronic transfer to at least one of the owner and the operator of the driven vehicle.

10. The method of claim 8, wherein a denial of approval is communicated to the operator and the operator modifies the reimbursement report and resubmits for disbursement processing, and subsequently, wherein upon receiving approval, the trip disbursement amount is provided via electronic transfer to at least one of the owner and the operator of the driven vehicle.

11. The method of claim 1, wherein deriving the geographically specific regional baseline cents-per-mile reimbursement rate based on the expected cost factors includes utilizing data that includes one or more of: vehicle registration data, vehicle ownership pattern data, vehicle ownership cost data, fuel mileage and cost data, or electric mileage and cost data, and driving costs.

12. The method of claim 11, wherein the expected cost factors include two or more of fuel cost, maintenance cost, depreciation cost, and tire cost.

13. The method of claim 12, wherein deriving the expected cost factors related to the operation of the sample vehicle includes calculating the expected cost factors using retrieved data obtained from sources external to the vehicle.

14. The method of claim 13, wherein the retrieved data includes at least one of vehicle registration data, vehicle ownership pattern data, and vehicle ownership cost data for a geographically specific region.

15. The method of claim 14, wherein the plurality of sensory input devices include at least one of a mobile device, a GPS device, a vehicle sensor, a vehicle onboard computer, and an OBD II module.

16. A method of dynamically calculating a reimbursement rate for vehicle usage comprising:
accessing from a data store, expected cost factors that include a plurality of specific expected costs for a sample vehicle;
deriving a geographically specific regional baseline cents-per-mile reimbursement rate that includes the expected cost factors;
accessing a geopoint trip record comprised of vehicle input data received from a driven vehicle and a sequence of geopoints obtained from at least one of a plurality of sensory input devices, wherein the sensory input devices are associated with the operation of the driven vehicle, and the geopoints include generated cost factors that include a plurality of specific generated costs for the driven vehicle,
individually comparing generated cost factors with associated expected cost factors to determine if the generated cost factors are greater than, less than, or equal to the expected cost factors;
generating a positive cost allotment for each generated cost factor that is greater than the associated expected cost factor;
generating a negative cost allotment for each generated cost factor that is less than the associated expected cost factor; and
deriving a dynamic cents-per-mile reimbursement rate by adjusting the geographically specific regional baseline cents-per-mile reimbursement rate; wherein the adjusting includes adding the positive cost allotments to the geographically specific regional baseline cents-per-mile reimbursement rate and subtracting the negative cost allotments.

17. The method of claim 16, further comprising calculating a trip disbursement amount that includes the dynamic cents-per-mile reimbursement rate multiplied by miles accrued on the driven vehicle during a trip and generating a reimbursement report that includes the trip disbursement amount.

18. The method of claim 17, further comprising electronically communicating the reimbursement report to at least one of an owner and an operator of the driven vehicle and submitting electronically via at least one of the owner and the operator of the driven vehicle, the reimbursement report for disbursement processing.

19. The method of claim 18, wherein the sensory input devices include one or more of a mobile device, a GPS device, a vehicle sensor, vehicle onboard computer, and an OBD II module.

20. The method of claim 19, wherein the expected cost factors and generated cost factors include driver behavior data.
